(19) United States
(12) Patent Application Publication
(10) Pub. No.: US 2003/0046814 A1
(43) Pub. Date: Mar. 13, 2003

(54) Method of making a sheet metal article with zones of different thickness

(75) Inventors: Hans-Jurgen Knaup, Bad Lippspringe (DE); Stefan Gosmann, Bad Wunnenberg (DE)

Correspondence Address: Ursula B. Day, Suite 3220, 350 Fifth Avenue, New York, NY, 10118, US

(73) Assignee: BENTELER AUTOMOBILTECHNIK GMBH & CO. KG, Paderborn (DE)

(21) Appl. No.: 10/211,999

(22) Filed: Aug. 2, 2002

(30) Foreign Application Priority Data
Sep. 13, 2001 (DE) 101 45 241.1

(51) Int. Cl. B21D 53/88; B23P 13/04; B23Q 7/00

(52) U.S. Cl. 29/897.2; 29/559; 29/557

(57) ABSTRACT

In a method of making a sheet metal article with varying thickness for fabricating a structural part for a motor vehicle, a blank of sheet metal is machined at least on one side along predetermined zones with a geometrically defined cutting tool to provide indentations of reduced thickness. Subsequently, the machined blank is subjected to a cold forming process or hot forming process.

### CROSS-REFERENCES TO RELATED APPLICATIONS

This application claims the priority of German Patent Application, Serial No. 101 45 241.1, filed Sep. 13, 2001, pursuant to 35 U.S.C. 119(a)-(d), the subject matter of which is incorporated herein by reference.

### BACKGROUND OF THE INVENTION

The present invention relates, in general, to a method of making a sheet metal article with zones of different thickness, for fabrication of structural parts for motor vehicles.

Sheet metal articles with varying thickness, preferably of steel sheet, are increasingly used in the automobile industry, because the weight of body parts can be reduced to suit their respective function. Examples of such body parts include “A” column, “B” column, “C” column, shock absorbers or their cross members, roof frames, side impact carriers, outer skin parts etc.

Heretofore, the use of so-called tailored blanks have been proposed, which involve a joining of metal sheets of same or different sheet thickness through welding. Also the use of so-called patchwork blanks is known, which involve sheet metal parts of varying thickness in parallel superimposed configuration.

Patchwork blanks have shortcomings because the spot welded joints are subjected to high stress during the shaping process and, on occasion, may also tear. In addition, the presence of a gap between the layers can lead to corrosive problems that require complex seals. Also, the transition between individual thickness zones in tailored blanks as well as patchwork blanks is relatively abrupt. As a consequence, undesired stress peaks may occur in the immediate transition zone.

Although the use of tailored blanks and patchwork blanks resulted in a significant weight reduction, without adversely affecting the reliability of the body parts, the production of such tailored or patchwork blanks is, however, complex, because metal sheets of varying thickness must be cut into strips and then joined together. Also, the sheet metal articles undergo a heat treatment during the joining operation, which may lead to adverse structural changes.

It is also known to employ hot forming and cold forming processes of metal sheets in rolling devices. German Pat. No. DE 42 31 213 describes, for example, the fabrication of formed bodies with different wall thicknesses from an initially flat sheet metal part, which is reduced in thickness in a cylinder mill along predetermined zones and subsequently further processed into a formed body. Similar approaches, for example for production of tubes with changing wall thickness, are described in German Pat. Nos. DE-PS 104 875 or DE 38 02 445 A1 or European Pat. No. EP 0 113 705 A1.

It would be desirable and advantageous to provide an improved method of making a sheet metal article with zones of varying thickness for fabrication of structural parts for motor vehicles, which method obviates prior art shortcomings and which allows highly variable thickness distribution in a sheet metal article to suit the sheet metal article to expected stress, while still realizing a weight reduction.

### SUMMARY OF THE INVENTION

According to one aspect of the present invention, in a method of making a sheet metal article with varying thickness for fabricating a structural part for a motor vehicle, a blank of sheet metal is machined, e.g. milling, at least on one side along predetermined zones with a geometrically defined cutting tool to provide indentations of reduced thickness, and then subjected to a cold forming process or hot forming process.

To ensure clarity, it is necessary to establish the definition of several important terms and expressions that will be used throughout this disclosure. The term “machining” refers to a process that involves any material removal process. The term “geometrically defined cutting tool” refers to a cutting tool in which the number of cutting edges, the shape of the cutting parts, and the position of the cutting edges with respect to the workpiece are known and defined.

A machining with a geometrically defined cutting tool results in an extremely accurate shaping of the workpiece. In particular, numerically controlled machine tools are suitable here, whereby the high-speed cutting process is especially advantageous.

Compared to patchwork blanks, sheet metal blanks that have been machined, are advantageous because of the resultant greater strength and because of the absence of any required welding operation to join two layers in flat engagement. Rather, the produced sheet metal article according to the present invention is of single-piece configuration. Zones of varying thickness, realized by the machining process, do not require seals, as necessary in patchwork blanks, so that the transition between individual zones may be configured in a very flexible manner, thereby affording new constructive options.

The absence of a heat treatment process for joining purposes, as required in patchwork blanks, eliminates the possibility of encountering structural changes. As a consequence, deformations and warping is less likely to occur, when the sheet metal article according to the present invention is later heated or tempered and quenched, compared to tailored blanks or patchwork blanks. Another advantage of sheet metal articles made through the method according to the present invention relates to sand blasting because blasted material will not penetrate into the sheet metal article, as has been encountered with tailored blanks or patchwork blanks.

The sheet metal blank may be machined, at least partially, on one side or on both sides.

According to another feature of the present invention, the sheet metal blank may be cut to size before the machining step. Suitably, the blank is flat. As a consequence of the simple handling capability and stacking capability, a flat sheet metal blank cut to size can be more easily shaped than plates that have been shaped to complex structural parts. Of course, the sheet metal article may still be shaped to a preformed body before the machining step, if this is beneficial for the production process.

According to another feature of the present invention, zones of the sheet metal article of different thicknesses can be machined in a way that provides gradual transitions between the zones. The provision of such flowing transitions saves material and results in a homogenous stress pattern in the transition between two zones of different thickness.

Although, it is basically possible to randomly select the thickness in individual zones, the machining process is economically viable only when the desired weight reduction is not accompanied by high production costs. Therefore, in accordance with another feature of the present invention, the difference in thickness between neighboring zones should be about 1 mm to 1.5 mm. Of course, a multiple of these differences in thickness is possible, for example, when three zones of different thickness are arranged in the form, whereby a zone of smallest thickness immediately neighbors a zone of greatest thickness.

According to another feature of the present invention, the sheet metal blank may be held in a chucking device during the machining step. Suitably, the blank is held during the clamping process by a magnetic clamping board or a vacuum clamping board. The use of vacuum clamping board is appropriate, when machining non-ferrous sheet metal blanks, e.g. of aluminum.

According to another feature of the present invention, the method involves also a welding of at least one further sheet metal article in overlapping relationship, at least in predetermined zones, to the sheet metal article. In this way, machined sheet metal articles can be joined together according to the concept of patchwork blanks, thereby allowing the production of very complex sheet metal articles, which can include very thin zones as well as relatively very thick zones. Thus, the further sheet metal article may have zones of varying thickness, realized through the machining process. The further sheet metal article may also be a patchwork blank or a tailored blank.

Of course, the starting material need not necessarily be a of single-piece configuration. Rather the use of a patchwork blank is also possible. Although patchwork blanks or tailored blanks have the afore-stated shortcomings compared to one-piece plates, the use of patchwork blanks or tailored blanks as starting material allows realization of great and small thicknesses.

Currently preferred is the use of sheet metal blank of a thickness of 5 mm or less, in the event single-piece sheet metal blanks are involved, and not patchwork blanks or tailored blanks.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic top view of a sheet metal article according to the present invention;

FIG. 2 is a side view of a sheet metal blank during machining operation into the sheet metal article;

FIG. 3 is a schematic top view of the sheet metal article in combination with a further sheet metal article; and

FIG. 4 is a side view of the combination of the two sheet metal articles.

### DETAILED DESCRIPTION OF PREFERRED EMBODIMENTS

Throughout all the Figures, same or corresponding elements are generally indicated by same reference numerals.

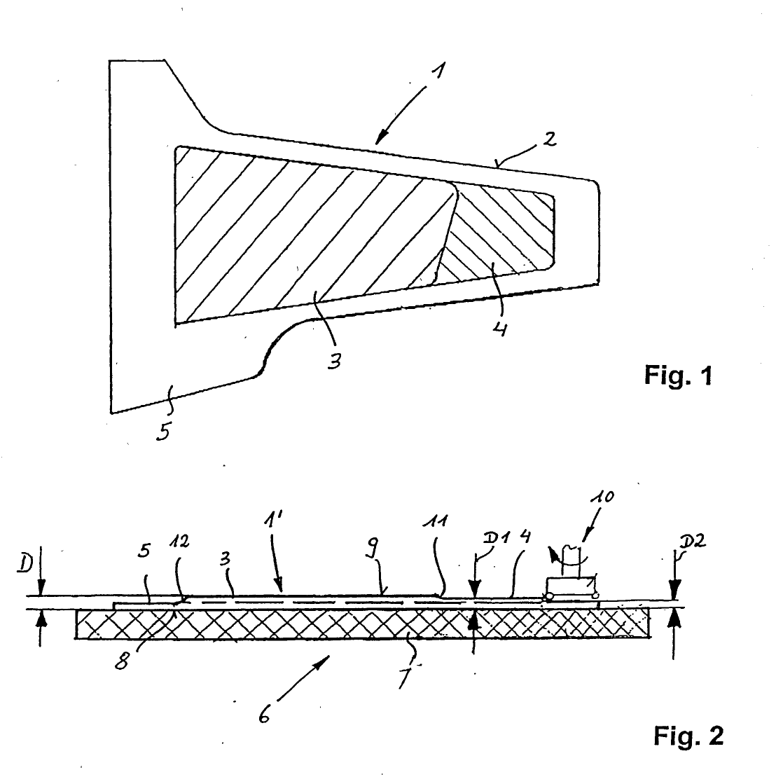

Turning now to the drawing, and in particular to FIG. 1, there is shown a schematic top view of a sheet metal article according to the present invention, generally designated by reference numeral 1 and configured in the form of a flat plate of sheet steel for subsequent fabrication of structural parts for motor vehicles. The sheet metal article 1 has been cut to size to define a substantially T-shaped outline 2 with three zones 3, 4, 5 of different thickness. As shown in particular in FIG. 2, the central zone 3 has a thickness D, which corresponds to the thickness of the initial sheet metal blank, 1′ (FIG. 2) used as starting material. Neighboring the zone 3 to the right in FIG. 2 is the zone 4, which has a reduced thickness D1 compared to the thickness D. The third zone 5 is located between the zones 3, 4, on the one hand, and the marginal contour 2 of the sheet metal article 1, on the other hand, and has a thickness D2 which is still further reduced compared to the thickness D1 of the zone 4.

As shown by the side view of FIG. 2, the sheet metal blank 1′ used as starting material for making the sheet metal article 1, has the thickness D, e.g. of 5 mm or less, and is held in a chucking device, generally designated by reference numeral 6. The chucking device 6 includes a magnetic clamping board 7 for electromagnetically securing the sheet metal blank 1′ in place, whereby the blank 1′ is placed with its underside 8 upon the clamping board 7, while its top side 9 is machined by a machining tool 10, e.g., a milling head rotating in a direction indicated by the arrow. FIG. 2 shows, by way of example, the machining operation of the third zone 5. Of course, the arrangement of a magnetic clamping board is described here by way of example only. Other embodiments, which generally follow the concepts outlined here, are considered to be covered by this disclosure, e.g., the use of a vacuum clamping board by which the blank 1′ is held in place through application of a vacuum.

As further shown in FIG. 2, a transition 11 between the zone 3 and the zone 4, and a transition 12 between the zone 3 and the zone 5, are rounded to thereby realize gradual or flowing transitions between the individual zones 3, 4, 5.

The thus cut and machined sheet metal article 1, fabricated by the method according to the present invention, can then be shaped to a structural part for subsequent use in a motor vehicle, e.g. by a cold forming or hot forming process.

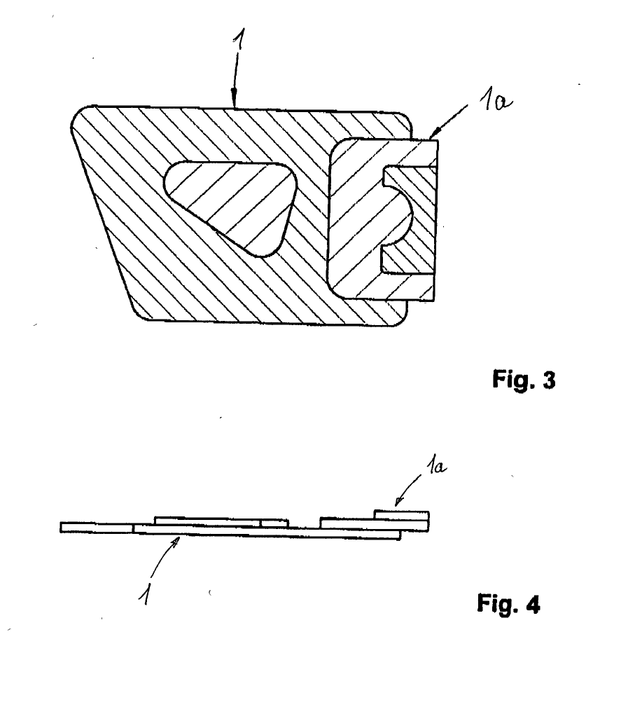

Turning now to FIGS. 3 and 4, there is shown the addition of a further sheet metal article 1 a in overlapping relationship, at least in predetermined zones, to the sheet metal article 1. Suitably, the sheet metal article 1a is welded to the sheet metal article 1. In this way, machined sheet metal articles can be joined together according to the concept of patchwork blanks, thereby allowing the production of very complex sheet metal articles, which can include very thin zones as well as relatively very thick zones. The sheet metal article 1a may also have zones of varying thickness, realized through the machining process. The further sheet metal article 1a may also be a patchwork blank or a tailored blank.

While the invention has been illustrated and described as embodied in a method of making a sheet metal article with zones of different thickness, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A method of making a sheet metal article with varying thickness for fabricating a structural part for a motor vehicle, comprising the steps of:
providing a blank of sheet metal having a thickness; machining the blank, at least on one side along predetermined zones, with a geometrically defined cutting tool to provide indentations of reduced thickness; and
subjecting the machined blank to one of cold forming process and hot forming process.

2. The method of claim 1, wherein the machining step is a milling step.

3. The method of claim 1, wherein the blank is cut to size before the machining step.

4. The method of claim 1, wherein the blank is flat.

5. The method of claim 1, wherein the blank is a preformed body.

6. The method of claim 1, wherein the zones have different thicknesses, with the machining step including providing gradual transitions between the zones.

7. The method of claim 1, wherein the blank is held in a chucking device during the machining step.

8. The method of claim 7, wherein the blank is held during the clamping process by a magnetic clamping board or a vacuum clamping board.

9. The method of claim 1, and further comprising the step of welding at least one machined sheet metal article in overlapping relationship, at least in predetermined zones, to a further sheet metal article.

10. The method of claim 9, wherein the further sheet metal article has zones of varying thickness.

11. The method of claim 1, wherein the sheet metal blank is a patchwork blank or tailored blank.

12. The method of claim 7, wherein the further sheet metal article is made form a patchwork blank or tailored blank.

13. The method of claim 1, wherein the thickness of the sheet metal blank is 5 mm or less.

14. The method of claim 1, wherein the difference in thickness between neighboring zones is about 1 mm to 1.5 mm.

15. A method of making a sheet metal article with varying, comprising the steps of providing a blank of sheet metal having a thickness; and machining the blank, at least on one side along predetermined zones, with a geometrically defined cutting tool to provide indentations of reduced thickness.
